(19) United States
(12) Patent Application Publication
(10) Pub. No.: US 2007/0214203 A1
(43) Pub. Date: Sep. 13, 2007

(54) Dividing method and apparatus

(75) Inventors: Hyeong-Seok Yu, Seoul (KR); Jae-Kon Lee, Suwon-si (KR); Chang-Woo Seo, Suwon-si (KR); Hyun-Il Kang, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/707,618

(22) Filed: Feb. 16, 2007

(30) Foreign Application Priority Data
Feb. 16, 2006 (KR) 15346/2006

(51) Int. Cl. G06F 17/14

(52) U.S. Cl. 708/400

(57) ABSTRACT

A dividing apparatus and method using coordinate rotation is disclosed. To this end, a plurality of rotation stages are sequentially performed until a divisor reaches a criterion and a rotation direction used in each of the plurality of stages is output. A division result acquired by performing rotation with respect to a dividend using the rotation direction for each of the plurality of stages is output.

### PRIORITY

This application claims the benefit under 35 U.S.C. § 119(a) of a Korean Patent Application filed in the Korean Intellectual Property Office on Feb. 16, 2006 and assigned Serial No. 2006-15346, the entire disclosure of which is hereby incorporated by reference.

### BACKGROUND OF THE INVENTION

1. Field of the Invention

The present invention generally relates to a dividing method and apparatus, and in particular, to a dividing method and apparatus to perform a division operation using coordinate rotation.

2. Description of the Related Art

Generally, the operation of four fundamental rules, which is the basis of all arithmetic operations, has been used in many calculation schemes and has been implemented variously as logical operators or software.

However, as is obvious to those skilled in the art, when implemented as logical operators or software, multiplication operations and divisions operation require complicated implementations. Therefore, a method for reducing the complexity of computation for multiplication operations and division operations while improving processing speed has been a goal to be pursued by those skilled in the art.

### SUMMARY OF THE INVENTION

An aspect of the present invention is to address at least the above problems and/or disadvantages and to provide at least the advantages described below. Accordingly, an aspect of the present invention is to provide an apparatus and method to perform a division operation using coordinate rotation.

Another aspect of the present invention is to provide an apparatus and method to perform a division operation when the remainder of the division operation is not required.

Another aspect of the present invention is to provide a dividing apparatus and method to improve the accuracy of a division result.

Another aspect of the present invention is to provide a dividing apparatus and method to simplify a division operation.

Another aspect of the present invention is to provide a dividing apparatus and method to minimize a chip area.

Another aspect of the present invention is to provide a dividing apparatus and method to acquire a division result by rotating a dividend using a rotation direction in each rotation stage in which a desired criterion is acquired by performing coordinate rotation on a divisor in each rotation stage.

Another aspect of the present invention is to provide a dividing apparatus and method to compensate for a rotation error caused in coordinate rotation with respect to a dividend.

Another aspect of the present invention is to provide a dividing apparatus and method to adjust a criterion for coordinate rotation according to the size of an input divisor.

Another aspect of the present invention is to provide a dividing apparatus and method to adjust a dividend according to adjustment of a criterion.

Another aspect of the present invention is to provide a dividing apparatus and method to compensate for a division result according to adjustment of a criterion.

Another aspect of the present invention is to provide a dividing apparatus and method to compensate for a division result according to adjustment of a criterion while compensating for a rotation error.

According to one aspect of the present invention, there is provided a dividing apparatus which receives a divisor and a dividend as inputs. The dividing apparatus includes a first Coordinate Rotation Digital Computer (CORDIC) for sequentially performing a plurality of rotation stages to cause the divisor to reach a criterion and outputting a rotation direction used in each of the rotation stages and a second CORDIC for outputting a division result acquired by rotating the dividend using the rotation direction output from the first CORDIC.

According to another aspect of the present invention, there is provided a dividing method. The dividing method comprises sequentially performing a plurality of rotation stages to cause a divisor to reach a criterion, performing a plurality of rotation stages on a dividend using a rotation direction used in each of the plurality of rotation stages with respect to the divisor, and outputting a value acquired in the final rotation stage out of the plurality of rotation stages as a division result, in which an output value from each of the rotation stages is input to the next rotation stage.

According to another aspect of the present invention, there is provided a dividing apparatus. The dividing apparatus includes a first Coordinate Rotation Digital Computer (CORDIC) for receiving a first source coordinate point having a divisor as an x-axis coordinate and 0 as a y-axis coordinate as an input, sequentially performing a plurality of rotation stages on the first source coordinate point to cause the first source coordinate point to reach a first target coordinate point having a criterion as an x-axis coordinate, and outputting a rotation direction used in each of the rotation stages and a second CORDIC for receiving a second source coordinate point having a dividend as an x-axis coordinate and 0 as a y-axis coordinate as an input and outputting a division result acquired by rotating the second source coordinate point using the rotation direction provided from the first CORDIC and a predetermined rotation angle for each of the rotation stages.

According to another aspect of the present invention, there is provided a dividing method. The dividing method includes sequentially performing a plurality of rotation stages on a first source coordinate point having a divisor as an x-axis coordinate and 0 as a y-axis coordinate to cause the first source coordinate point to reach a first target coordinate point having a criterion as an x-axis coordinate, outputting a rotation direction used in each of the rotation stages, acquiring a second target coordinate point by rotating a second source coordinate point having a dividend as an x-axis coordinate and 0 as a y-axis coordinate using the rotation direction and a predetermined rotation angle for each of the rotation stages, and outputting an x-axis coordinate of the second target coordinate point as a division result.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 illustrates the structure of a dividing apparatus according to the present invention;

FIG. 2 illustrates rotation performed by a master Coordinate Rotation DIgital Computer (CORDIC) according to the present invention;

FIG. 3 illustrates the detailed structure of a master CORDIC according to the present invention;

FIG. 4 illustrates the detailed structure of a CORDIC ladder included in a master CORDIC according to the present invention;

FIG. 5 illustrates the detailed structure of a slave CORDIC according to the present invention;

FIG. 6 illustrates the detailed structure of a CORDIC ladder included in a slave CORDIC according to the present invention;

FIG. 7 illustrates a coordinate rotation error caused in a dividing apparatus according the present invention;

FIG. 8 illustrates the detailed structure of a dividing apparatus according to the present invention;

FIG. 9 illustrates the detailed structure of a dividing apparatus according to the present invention;

FIG. 10 illustrates the detailed structure of a dividing apparatus according to the present invention; and

FIG. 11 illustrates the detailed structure of a dividing apparatus according to the present invention.

### DETAILED DESCRIPTION OF THE PREFERRED EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Terms used herein are defined based on functions in the present invention and may vary according to users, operators' intention or usual practices. Therefore, the definition of the terms should be made based on contents throughout the specification.

The present invention suggests a division operation using a Coordinate Rotation DIgital Computer (CORDIC). Generally, the CORDIC performs polar coordinate rotation on a specific coordinate point on a two-dimensional (2D) coordinate system. The position of the specific coordinate point is expressed as ‘vector (a, b)’ by a coordinate ‘a’ on the horizontal axis (or x axis) and a coordinate ‘b’ on the vertical axis (or y axis).

By using the characteristics of the CORDIC, a vector expressing the position of a specific coordinate point, which hereinafter will be referred to as a “source coordinate point”, can be rotated by a predetermined angle. The CORDIC can compute the position of a new coordinate point that is set by the rotation, which hereinafter will be referred to as a “target coordinate point”. The CORDIC can also compute the magnitude of the vector or an angle. The angle is an angle between the vector and the x axis or the y axis.

To this end, the CORDIC receives information about the source coordinate point and a criterion as inputs. The information about the source coordinate point includes a coordinate on the horizontal axis (x axis) and a coordinate on the vertical axis (y axis) of the source coordinate point and an angle between a vector corresponding to the source coordinate point and the horizontal axis (x axis) or the vertical axis (y axis). The criterion determines the target coordinate point to be acquired by coordinate rotation and is determined by a horizontal-axis (x-axis) coordinate or a vertical-axis (y-axis) coordinate of the target coordinate point or an angle of rotation to the source coordinate point.

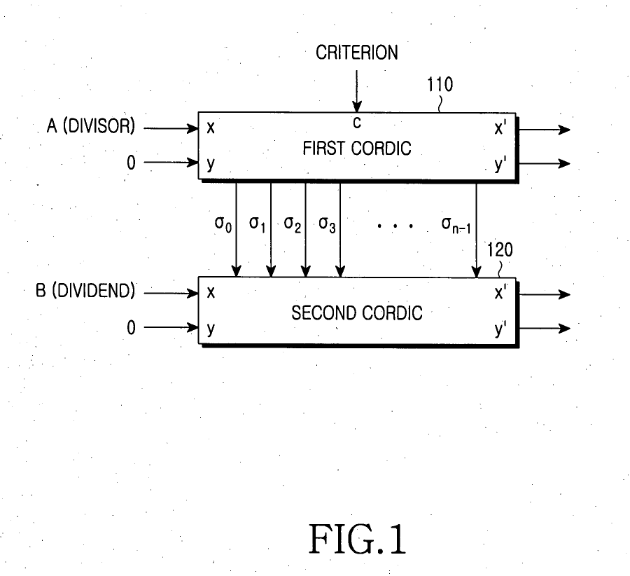

FIG. 1 illustrates the structure of a dividing apparatus according to a first exemplary embodiment of the present invention, in which two CORDICs are used. One of the CORDICs is used as a master and the other is used as a slave. In the present invention, the master CORDIC will be referred to as a first CORDIC and the slave CORDIC will be referred to as a second CORDIC. A coordinate point input to the first CORDIC will be referred to as a first source coordinate point and a coordinate point output from the first CORDIC will be referred to as a first target coordinate point. A coordinate point input to the second CORDIC will be referred to as a second source coordinate point and a coordinate point output from the second CORDIC will be referred to as a second target coordinate point.

Referring to FIG. 1, a first CORDIC 110 receives a divisor A and a criterion. In other words, the first CORDIC 110 receives the divisor A as a horizontal-axis (x-axis) coordinate of the first source coordinate point and receives the criterion, i.e., a constant that does not exert an influence upon a division result, as a vertical-axis (y-axis) coordinate of the first source coordinate point. Alternatively, the first CORDIC 110 may also receive the divisor A as the vertical-axis (y-axis) coordinate of the first source coordinate point and receives the criterion, i.e., a constant that does not exert an influence upon a division result, as the horizontal-axis (x-axis) coordinate of the first source coordinate point. The criterion may differ according to which one of the horizontal-axis (x-axis) coordinate and the vertical-axis (y-axis) coordinate the divisor A is input to. If the divisor A is input as the horizontal-axis (x-axis) coordinate of the first source coordinate point, the criterion becomes a horizontal-axis (x-axis) coordinate of the first target coordinate point. If the divisor A is input as the vertical-axis (y-axis) coordinate of the first source coordinate point, the criterion becomes a vertical-axis (x-axis) coordinate of the first target coordinate point.

In FIG. 1, the divisor A is input as the horizontal-axis (x-axis) coordinate of the first source coordinate point and ‘0’ is input as the vertical-axis (y-axis) coordinate of the first source coordinate point. In other words, the position of the first source coordinate point is expressed as ‘vector (A, 0)’. Thus, the criterion becomes the horizontal-axis (x-axis) coordinate of the first target coordinate point. The criterion may be determined by the size of the divisor A. However, the criterion should not exceed the divisor A. For example, the criterion may be a multiplier of 2 that does not exceed the divisor A and generally may be set to ‘1’.

The first CORDIC 110 rotates the first source coordinate point to the first target coordinate point. The x-axis coordinate of the first target coordinate point is the criterion. The magnitude of a vector corresponding to the first target coordinate point is set equal to that of the vector corresponding to the first source coordinate point.

The first CORDIC 110 rotates the first source coordinate point according to a predetermined angle and a rotation direction. The rotation operation is performed by the first CORDIC 110 through a plurality of rotation stages and rotation is performed sequentially in each of the rotation stages. The rotation in each of the rotation stages is performed based on a rotation direction and a rotation angle. The rotation angle is the angle of rotation of a vector and decreases as the rotation stages progress. In other words, the rotation angle in a current rotation stage is less than the rotation angle in a previous rotation stage.

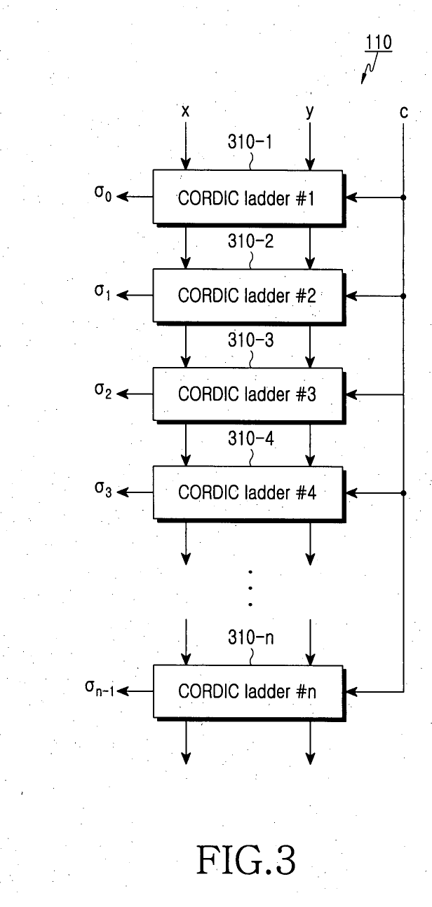

As mentioned above, the rotation direction is determined for the rotation in each of the rotation stages, as will be described in detail with reference to FIG. 3. Since the rotation is performed in a current rotation stage with a smaller angle (rotation angle) than in a previous rotation stage, it is obvious that the rotation operation is performed more precisely as the rotation stages progress.

The first CORDIC 110 rotates the first source coordinate point until the x-axis coordinate of the first source coordinate point matches with the criterion. Thus, the first CORDIC 110 may output the criterion as the x-axis coordinate of the first target coordinate point and may output an unspecific value as the y-axis coordinate of the first target coordinate point. The x-axis coordinate of the first target coordinate point may not perfectly match with the criterion due to a rotation error. The rotation error can be compensated for by a scaling factor. However, the present invention does not require the perfect match between the x-axis coordinate of the first target coordinate point and the criterion, and thus compensation using the scaling factor is not performed. Since the y-axis coordinate of the first target coordinate point has no influence upon the present invention, it will not be considered.

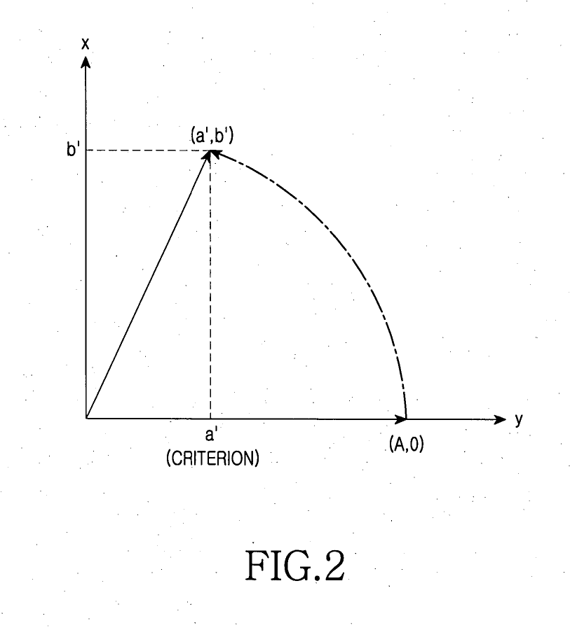

The first CORDIC 110 provides to a second CORDIC 120 the rotation direction in each of the rotation stages. In FIG. 2, n rotation stages will be assumed. The first CORDIC 110 provides n rotation directions σ₀, σ₁, σ₂, σ₃, . . . , σₙ₋₁ to the second CORDIC 120.

The second CORDIC 120 receives a dividend B, and the n rotation directions σ₀, σ₁, σ₂, σ₃, . . . , σₙ₋₁ provided from the first CORDIC 110. The dividend B is input as a horizontal-axis (x-axis) coordinate of a second source coordinate point and a constant that has no influence upon a division result is input as a vertical-axis (y-axis) coordinate of the second source coordinate point. Alternatively, the dividend B may be input as the vertical-axis (y-axis) coordinate of the second source coordinate point and a constant that has no influence upon a division result may be input as the horizontal-axis (x-axis) coordinate of the second source coordinate point. In FIG. 1, the dividend B is input as the horizontal-axis (x-axis) coordinate of the second source coordinate point and ‘0’ is input as the vertical-axis (y-axis) coordinate of the second source coordinate point. Thus, the position of the second source coordinate point is expressed by ‘vector (B,0)’.

The second CORDIC 120 rotates the second source coordinate point based on a predetermined angle and the rotation directions provided from the first CORDIC 110. In other words, the rotation operation is performed by the second CORDIC 120 through a plurality of rotation stages and rotation by a predetermined angle is performed sequentially in each of the rotation stages. The rotation in each of the rotation stages is performed using the rotation directions σ₀, σ₁, σ₂, σ₃, . . . , σₙ₋₁ provided from the first CORDIC 110.

The second CORDIC 120 outputs a horizontal-axis (x-axis) coordinate and a vertical-axis (y-axis) coordinate of a second target coordinate point acquired by rotating the second source coordinate point. The horizontal-axis (x-axis) coordinate output from the second CORDIC 120 is a division result (B/A). The vertical-axis (y-axis) coordinate output from the second CORDIC 120 has no influence upon the present invention and thus will not be considered.

The dividing apparatus according to the present invention includes a structure in which the first CORDIC 110 for rotating vector (A, 0) using the divisor A and the second CORDIC 120 for rotating vector (B, 0) using the dividend B are interconnected to each other.

The first CORDIC 110 determines a rotation direction a using the criterion and the divisor A. In other words, the first CORDIC 110 outputs the rotation directions σ₀, σ₁, σ₂, σ₃, . . . , σₙ₋₁, which are used in the plurality of rotation stages for rotating vector (A, 0) to the criterion, to the second CORDIC 120.

The second CORDIC 120 rotates the dividend B according to the rotation directions σ₀, σ₁, σ₂, σ₃, . . . , σₙ₋₁ provided from the first CORDIC 110, thereby outputting a desired division result B/A.

FIG. 2 illustrates rotation performed by the first CORDIC 110.

Referring to FIG. 2, a source coordinate point (A, 0) is rotated to a target coordinate point (a′, b′). The x-axis coordinate a′ of the target coordinate point (a′, b′) is a predetermined criterion. The magnitude of a vector corresponding to the source coordinate point (A, 0) is equal to the magnitude of vector corresponding to the target coordinate point (a′, b′). In other words, the magnitude of the vector corresponding to the target coordinate point (a′, b′) is A.

FIG. 3 illustrates the detailed structure of the first CORDIC 110. In FIG. 3, n rotation stages are assumed. ‘n’ can be determined by considering the acquisition of an accurate target coordinate point and the amount of computation. In other words, as n increases, an accurate target coordinate point can be acquired, but the amount of computation will increase. On the other hand, as n decreases, the amount of computation can decrease, but an error may occur in the computed target coordinate point.

Referring to FIG. 3, output values of CORDIC ladders 310-1 through 310-(n-1), are input to CORDIC ladders 310-2 through 310-n, respectively. For example, an output value of the second CORDIC ladder 310-2 is input to the third CORDIC ladder 310-3.

The divisor A and a constant that has no influence upon a division result are input to the first CORDIC ladder 310-1. The constant may be ‘0’.

Each of the CORDIC ladders 310-1 through 310-n determines a rotation direction σᵢ using the divisor A or an output value from its immediately previous ladder and the criterion. Here, i is an index indicating a rotation stage and is an integer that is greater than or equal to 0 and is less than n. The rotation direction σᵢ is determined so that the divisor A or the output value from the previous ladder can approximate the criterion.

Each of the CORDIC ladders 310-1 through 310-n performs rotation with respect to the divisor A or the output value from its previous ladder using the determined rotation direction σᵢ and a predetermined rotation angle. The rotation direction σᵢ used in each of the CORDIC ladders 310-1 through 310-n is output to each CORDIC ladder of the second CORDIC 120.

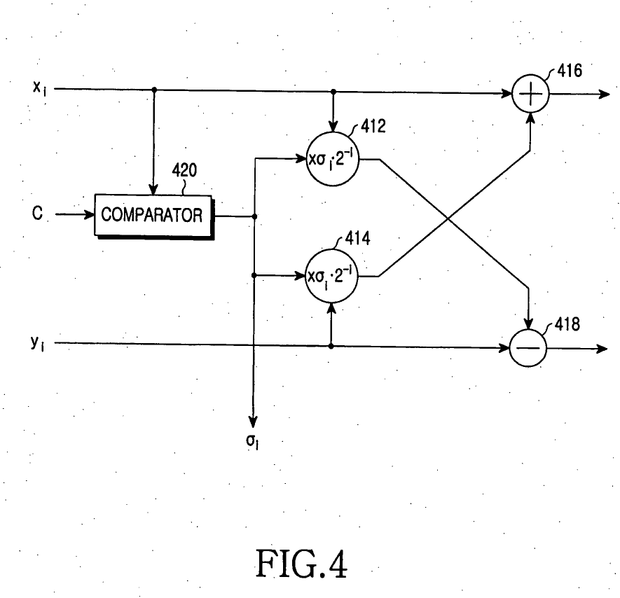

FIG. 4 illustrates the detailed structure of a CORDIC ladder 310 included in the first CORDIC 110. In FIG. 4, xᵢ is the divisor A or an output value xᵢ from a previous CORDIC ladder and yᵢ is 0 or an output value yᵢ from a previous CORDIC ladder.

Referring to FIG. 4, a comparator 410 compares a criterion c with xᵢ and determines the rotation direction σᵢ according to the comparison result. For example, if xᵢ is greater than the criterion c, the comparator 410 determines the rotation direction σᵢ in such a way to reduce xᵢ. If xᵢ is less than the criterion c, the comparator 410 determines the rotation direction σᵢ in such a way to increase xᵢ. The rotation direction σᵢ for reducing xᵢ may be a direction in which an angle between a rotated vector and the x axis increases and the rotation direction σᵢ for increasing xᵢ may be a direction in which the angle between the rotated vector and the x axis decreases. For example, the rotation direction σᵢ for reducing xᵢ may be +1 and the rotation direction σᵢ for increasing xᵢ may be −1. In this case, the comparator 410 outputs +1 for xᵢ>c and outputs −1 for xᵢ<c.

A first multiplier 412 multiplies xᵢ, σᵢ, and 2⁻ⁱ resulting from the predetermined rotation angle. The first multiplier 412 rotates xᵢ by 2⁻ⁱ in the rotation direction σᵢ. A second multiplier 414 multiplies yᵢ, σᵢ, and 2⁻ⁱ resulting from the predetermined rotation angle together. In other words, the second multiplier 414 rotates yᵢ by 2⁻ⁱ in the rotation direction σᵢ. Here, it can be seen from 2⁻ⁱ resulting from the predetermined rotation angle that the rotation angle decreases as the rotation stages progress. In other words, addition or subtraction is performed with respect to a value shifted by 1 bit in each rotation stage according to a rotation direction.

An adder 416 performs an addition operation on xᵢ and an output value of the second multiplier 414 to output xᵢ₊₁. A subtracter 418 performs a subtraction operation on yᵢ and an output value of the first multiplier 412 to output yᵢ₊₁. xᵢ₊₁ and xᵢ₊₁ may be input values to the next CORDIC ladder or final output values of the first CORDIC 110.

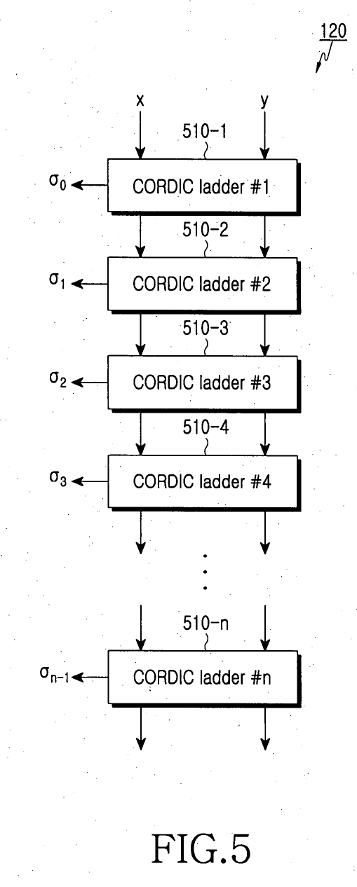

FIG. 5 illustrates the detailed structure of the second CORDIC 120. In FIG. 5, n rotation stages are assumed. ‘n’ can be determined by considering the acquisition of an accurate target coordinate point and the amount of computation. In other words, as n increases, an accurate target coordinate point can be acquired, but the amount of computation will increase. On the other hand, as n decreases, the amount of computation can decrease, but an error may occur in the computed target coordinate point.

Referring to FIG. 5, output values of CORDIC ladders 510-1 through 510-(n-1) are input to CORDIC ladders 510-2 through 510-n, respectively. For example, an output value of the second CORDIC ladder 510-2 is input to the third CORDIC ladder 510-3.

The dividend B and a constant that has no influence upon a division result are input to the first CORDIC ladder 510-1. The constant may be ‘0’.

Each of the CORDIC ladders 510-1 through 510-n performs rotation with respect to the dividend B or the output value from its previous ladder using the rotation direction σᵢ input from the first CORDIC 110 and a predetermined rotation angle. Here, i is an index indicating a rotation stage and is an integer that is equal to or greater than 0 and is less than n. Thus, the rotation direction σᵢ is provided to an (i+1)^{th} CORDIC ladder.

The last CORDIC ladder 510-n outputs a desired division result B/A acquired by rotating the output value from its previous CORDIC ladder 510-(n-1) by the predetermined rotation angle in the rotation direction σᵢ₋₁. In FIG. 5, x′ is the division result B/A.

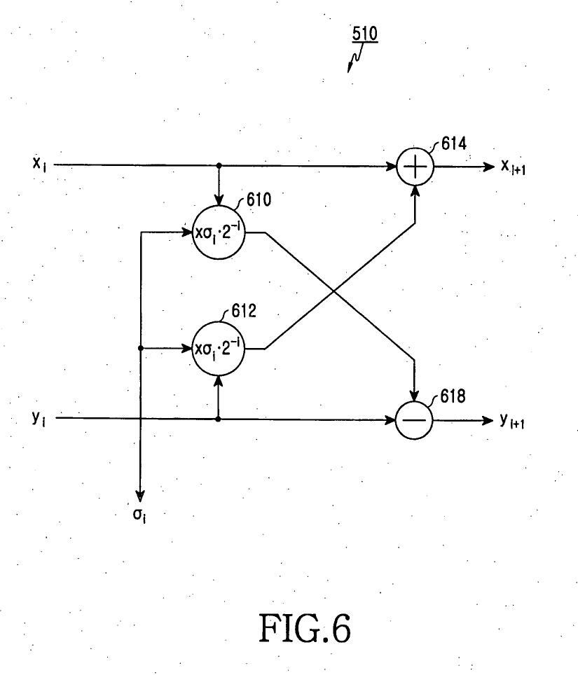

FIG. 6 illustrates the detailed structure of a CORDIC ladder 510 included in the second CORDIC 120. In FIG. 6, xᵢ is the dividend B or an output value xᵢ from a previous CORDIC ladder and yᵢ is 0 or an output value yᵢ from a previous CORDIC ladder.

Referring to FIG. 6, a first multiplier 610 multiplies xᵢ, σᵢ, and 2⁻ⁱ resulting from the predetermined rotation angle together. In other words, the first multiplier 610 rotates xᵢ by 2⁻ⁱ in the rotation direction σᵢ. A second multiplier 612 multiplies yᵢ, σᵢ, and 2⁻ⁱ resulting from the predetermined rotation angle together. In other words, the second multiplier 612 rotates yᵢ by 2⁻ⁱ in the rotation direction σᵢ.

An adder 614 performs an addition operation on xᵢ and an output value of the second multiplier 612 to output xᵢ₊₁. A subtracter 618 performs a subtraction operation on yᵢ and an output value of the first multiplier 610 to output yᵢ₊₁. xᵢ₊₁ and yᵢ₊₁ may be input values to the next CORDIC ladder or final output values of the second CORDIC 120.

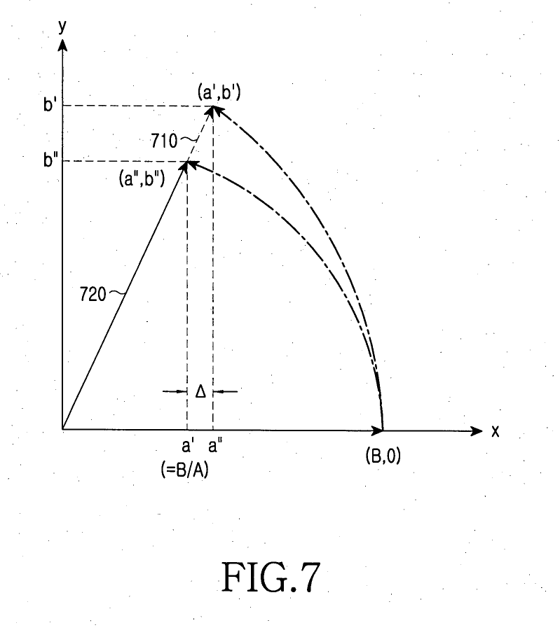

FIG. 7 illustrates a coordinate rotation error caused in a final result acquired by the dividing apparatus suggested in FIG. 1. A coordinate rotation error occurring in a final result output from the second CORDIC 120 is shown in FIG. 7.

In FIG. 7, vector (a′, b′) 710 is a vector corresponding to a target coordinate point output from the second CORDIC 120 and vector (a″, b″) 720 is a vector corresponding to a desired target coordinate point. As can be seen from FIG. 7, vector (a′, b′) 710 and vector (a″, b″) 720 have different magnitudes although having the same direction as each other. Thus, the actual target coordinate point and the desired target coordinate point have predetermined errors therebetween in an x-axis coordinate and a y-axis coordinate. In the present invention, the x-axis coordinate is a final division result and thus a method for compensating for a coordinate rotation error Δ on the x-axis has to be provided.

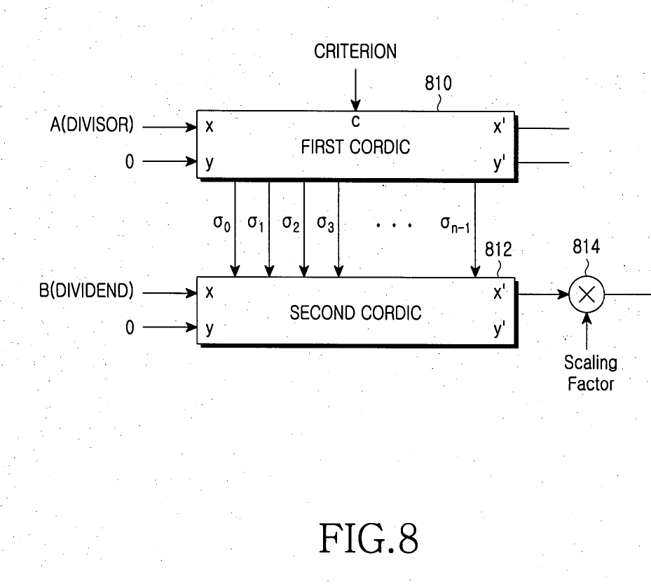

FIG. 8 illustrates the detailed structure of a dividing apparatus according to a second exemplary embodiment of the present invention, which compensates for the coordinate rotation error on the x-axis shown in FIG. 7. As shown in FIG. 8, the present invention compensates for a coordinate rotation error only for an x-axis output value of a second CORDIC 812. This is because an x-axis output value and a y-axis output value of a first CORDIC 810 and a y-axis output value of the second CORDIC 812 have no influence upon a final result of the dividing apparatus, as discussed above.

Referring to FIG. 8, the dividing apparatus further includes a multiplier 814 for compensating for only a coordinate rotation error associated with a division result, out of coordinate rotation errors of a final result that may be caused by the first CORDIC 810 and the second CORDIC 812. The multiplier 814 multiplies an x-axis output value of the second CORDIC 812 by a predetermined scaling factor. The scaling factor may be determined based on the characteristics of each CORDIC ladder of the second CORDIC 812. In other words, an increase rate of an x-axis output value compensated using the scaling factor during coordinate rotation of each CORDIC ladder can be preset. Increase rates generated in CORDIC ladders of the second CORDIC 812 are summed and the scaling factor may be calculated using the sum.

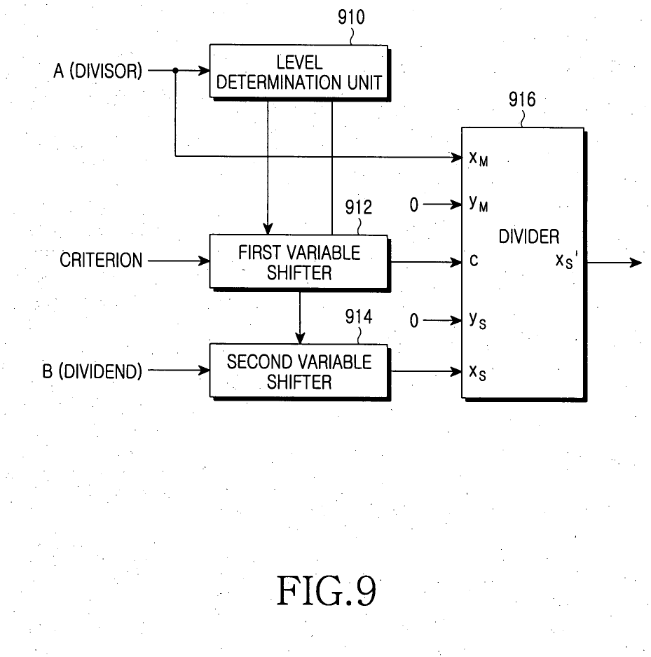

FIGS. 9 through 11 illustrate the structure of a dividing apparatus according to other exemplary embodiments of the present invention. In FIGS. 9 through 11, a multiplier may be implemented with a structure shown in FIG. 1 or 8. In FIGS. 9 through 11, a criterion is adjusted according to the size of a divisor in order to further improve the accuracy of a division result. The accuracy of a division result may be further improved using as the criterion the maximum value that is not greater than a divisor. However, for convenience of implementation, a value that can be expressed as a multiplier of 2 and is not greater than a divisor, is used as the criterion in the present invention. The value that can be expressed as a multiplier of 2 is used because the criterion can be easily adjusted using a shifter. Moreover, in FIGS. 9 through 11, a dividend is adjusted in inverse proportion to the adjustment of the criterion. This is because the adjusted criterion may have an influence upon a division result.

Referring to FIG. 9, a level determination unit 910 determines a level corresponding to the size of a divisor A from among preset levels. The level determination unit 910 specifies a divisor range corresponding to each level. When the divisor A is input, a level corresponding to a divisor range within which the size of the input divisor A falls is determined as a level corresponding to the divisor A. For example, on the assumption that the divisor A is decimal, if the divisor A is between 1 and 2, its level is determined as a level #1. If the divisor A is between 3 and 4, its level is determined as a level #2. If the divisor A is between 5 and 8, its level is determined as a level #3. For generalization, a level corresponding to a divisor falling within a range 2ⁱ⁻¹-2ⁱ is determined as a level #i.

A first variable shifter 912 adjusts a criterion. The amount of adjustment is determined by a level provided from the level determination unit 910. For example, on the assumption that the divisor A is binary, if the level #1 is provided from the level determination unit 910, the criterion is output without being adjusted. If the level #2 is provided from the level determination unit 910, the criterion is shifted to the left by 1 bit as if it is multiplied by 2. In other words, if a level #i is provided from the level determination unit 910, the first variable shifter 912 shifts the criterion by (i−1) bits to the left.

A second variable shifter 914 shifts the dividend B in the opposite direction to the shifting direction in the first variable shifter 914.

A divider 916 receives the divisor A, the adjusted criterion, and the adjusted dividend B and outputs the division result B/A according to the division operation suggested before.

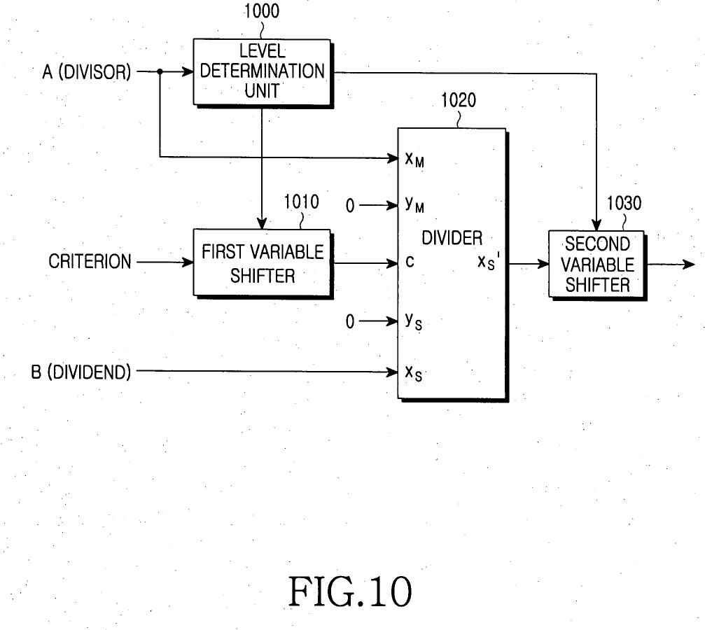

A dividing apparatus suggested in FIG. 10 adjusts a division result according to adjustment of a criterion.

Referring to FIG. 10, a level determination unit 1000 determines a level corresponding to the size of an input divisor A, out of preset levels. The level determination unit 1000 specifies a divisor range corresponding to each level. When the divisor A is input, the level determination unit 1000 determines a level corresponding to a divisor range within which the size of the input divisor A falls as a level corresponding to the divisor A. For example, on the assumption that the divisor A is decimal, if the divisor A is between 1 and 2, its level is determined as a level #1. If the divisor A is between 3 and 4, its level is determined as a level #2. If the divisor A is between 5 and 8, its level is determined as a level #3. For generalization, a level corresponding to a divisor falling within a range 2ⁱ⁻¹-2ⁱ is determined as a level #i.

A first variable shifter 1010 adjusts a criterion. The amount of adjustment is determined by a level provided from the level determination unit 1000. For example, on the assumption that the criterion is binary, if the level #1 is provided from the level determination unit 1000, the criterion is output without being adjusted. If the level #2 is provided from the level determination unit 1000, the criterion is shifted to the left by 1 bit as if it is multiplied by 2. In other words, if a level #i is provided from the level determination unit 1000, the first variable shifter 1010 shifts the criterion by (i−1) bits to the left.

A divider 1020 receives the divisor A, the adjusted criterion, and the adjusted dividend B and outputs the division result B/A according to the division operation suggested before. At this time, the division result is acquired using the criterion adjusted by the first variable shifter 1010. In other words, the division result can be expressed as 2ⁱ⁻¹·B/A. Therefore, in order to acquire an accurate division result, an operation for eliminating 2ⁱ⁻¹ from 2ⁱ⁻¹·B/A.

A second variable shifter 1030 shifts the division result of the divider 1020 in the opposite direction to the shifting direction in the first variable shifter 1010, thereby eliminating 2ⁱ⁻¹ from 2ⁱ⁻¹·B/A. In other words, the second variable shifter 1030 shifts 2ⁱ⁻¹·B/A to the right by (i−1) bits.

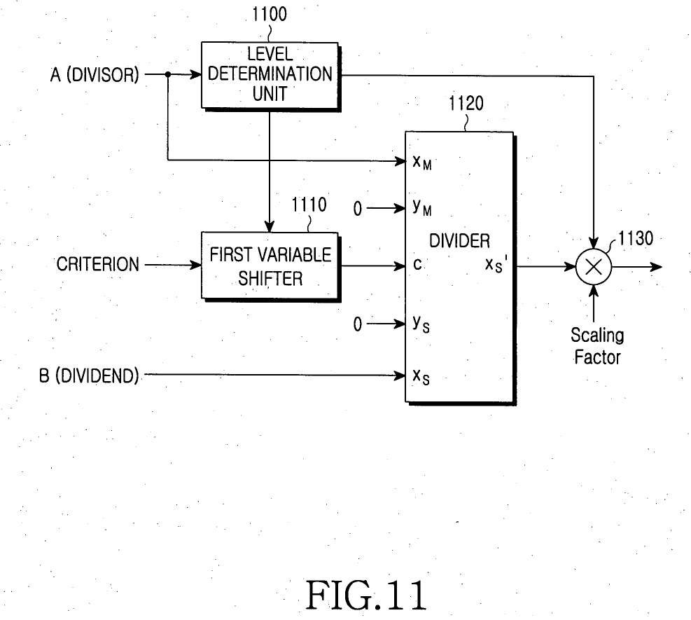

A dividing apparatus suggested in FIG. 11 adjusts a division result using a scaling factor according to adjustment of a criterion.

Referring to FIG. 11, a level determination unit 1100 determines a level corresponding to the size of an input divisor A, out of preset levels. The level determination unit 1100 specifies a divisor range corresponding to each level. When the divisor A is input, the level determination unit 1100 determines a level corresponding to a divisor range within which the size of the input divisor A falls as a level corresponding to the divisor A. For example, on the assumption that the divisor A is decimal, if the divisor A is between 1 and 2, its level is determined as a level #1. If the divisor A is between 3 and 4, its level is determined as a level #2. If the divisor A is between 5 and 8, its level is determined as a level #3. For generalization, a level corresponding to a divisor falling within a range 2ⁱ⁻¹-2ⁱ is determined as a level #i.

A first variable shifter 1110 adjusts a criterion. The amount of adjustment is determined by a level provided from the level determination unit 1100. For example, on the assumption that the criterion is binary, if the level #1 is provided from the level determination unit 1100, the criterion is output without being adjusted. If the level #2 is provided from the level determination unit 1000, the criterion is shifted to the left by 1 bit as if it is multiplied by 2. In other words, if a level #i is provided from the level determination unit 1100, the first variable shifter 1110 shifts the criterion by (i−1) bits to the left.

A divider 1120 receives the divisor A, the adjusted criterion, and the adjusted dividend B and outputs the division result B/A according to the division operation suggested before. At this time, the division result is acquired using the criterion adjusted by the first variable shifter 1110. In other words, the division result can be expressed as 2ⁱ⁻¹·B/A. Therefore, in order to acquire an accurate division result, an operation for eliminating 2ⁱ⁻¹ from 2ⁱ⁻¹·B/A.

A multiplier 1130 multiplies the division result output from the divider 1120 by a scaling factor, thereby outputting the final division result B/A in which a coordinate rotation error generated in the divider 1120 and 2ⁱ⁻¹ are compensated for. The scaling factor has to be determined in consideration of coordination rotation errors that are predictable from the number of CORDIC ladders of CORDICs of the divider 1120 and the amount of adjustment made by the first variable shifter 1110.

As is apparent from the above description, the present invention performs a division operation only using coordinate rotation, thereby reducing the complexity of the division operation and a chip area. Moreover, by simplifying the division operation, a manufacturing cost can be reduced.

While the invention has been shown and described with reference to exemplary embodiments thereof, it will be understood by those skilled in the art that various changes in form and details may be made therein without departing from the spirit and scope of the invention.

What is claimed is:

1. A dividing apparatus which receives a divisor and a dividend as inputs, the dividing apparatus comprising:
a first Coordinate Rotation Digital Computer (CORDIC) for sequentially performing a plurality of rotation stages to cause the divisor to reach a criterion and outputting a rotation direction used in each of the rotation stages; and
a second CORDIC for outputting a division result acquired by rotating the dividend using the rotation direction output from the first CORDIC.

2. The dividing apparatus of claim 1, wherein the first CORDIC comprises a plurality of CORDIC ladders corresponding to the plurality of rotation stages, each of which compares the divisor or an output value from a previous CORDIC ladder with the criterion and outputs the rotation direction based on the comparison result.

3. The dividing apparatus of claim 2, wherein the first CORDIC determines the rotation direction to reduce the divisor or the output value from the previous CORDIC ladder if the divisor or the output value from the previous CORDIC ladder is greater than referring to the description of FIG. 4, the previous output value could access the maximum approximate value of the reference value, it is impossible to be accord with the reference value. Accordingly, the present invention does not consider the operation of the comparator in case the reference value is the same as the previous output value.) the criterion and determines the rotation direction in such a way to increase the divisor or the output value from the previous CORDIC ladder if the divisor or the output value from the previous CORDIC ladder is less than the criterion.

4. The dividing apparatus of claim 1, wherein the second CORDIC comprises a plurality of CORDIC ladders corresponding to the plurality of rotation stages, each of which rotates the dividend or an output value from a previous CORDIC ladder using the rotation direction provided from the first CORDIC and a predetermined rotation angle for each of the rotation stages.

5. The dividing apparatus of claim 2, wherein the second CORDIC comprises a plurality of CORDIC ladders corresponding to the plurality of rotation stages, each of which rotates the dividend or an output value from a previous CORDIC ladder using the rotation direction provided from the first CORDIC and a predetermined rotation angle for each of the rotation stages.

6. The dividing apparatus of claim 4, wherein when an index indicating each of the rotation stages is i, the predetermined rotation angle is tan⁻¹(2⁻ⁱ).

7. The dividing apparatus of claim 1, further comprising a multiplier for multiplying the division result output from the second CORDIC by a scaling factor.

8. The dividing apparatus of claim 7, wherein the scaling factor is determined using an increase rate in each of the rotation stages.

9. The dividing apparatus of claim 1, further comprising:
a level determination unit for determining a level corresponding to the divisor;
a first variable shifter for adjusting the criterion using the determined level and outputting the adjusted criterion to the first CORDIC; and
a second variable shifter for adjusting the dividend using the determined level and outputting the adjusted dividend to the second CORDIC.

10. The dividing apparatus of claim 1, further comprising:
a level determination unit for determining a level corresponding to the divisor;
a first variable shifter for adjusting the criterion using the determined level and outputting the adjusted criterion to the first CORDIC; and
a second variable shifter for adjusting an output value of the first CORDIC using the determined level and outputting the adjusted value as a division result.

11. The dividing apparatus of claim 1, wherein the criterion is the maximum value among multiplies of 2 that are less than the divisor.

12. A dividing method, comprising:
sequentially performing a plurality of rotation stages to cause a divisor to reach a criterion;
performing a plurality of rotation stages on a dividend using a rotation direction used in each of the plurality of rotation stages with respect to the divisor; and
outputting a value acquired in the final rotation stage out of the plurality of rotation stages as a division result,
wherein an output value from each of the rotation stages is input to the next rotation stage.

13. The dividing method of claim 12, wherein the rotation direction used in each of the rotation stages is determined by the result of comparison between the divisor or an output value from a previous rotation stage and the criterion.

14. The dividing method of claim 13, further comprising:
determining the rotation direction to reduce the divisor or the output value from the previous rotation stage if the divisor or the output value from the previous rotation stage is greater than the criterion; and
determining the rotation direction in such a way to increase the divisor or the output value from the previous rotation stage if the divisor or the output value from the previous rotation stage is less than the criterion.

15. The dividing method of claim 12, wherein a rotation angle used in each of the rotation stages with respect to the dividend is tan⁻¹(2⁻ⁱ), in which i is an index indicating each of the rotation stages.

16. The dividing method of claim 12, further comprising multiplying the division result by a scaling factor.

17. The dividing method of claim 16, wherein the scaling factor is determined by an increase rate in each of the rotation stages.

18. The dividing method of claim 12, further comprising:
determining a level corresponding to the divisor;
adjusting the criterion using the determined level; and
adjusting the dividend using the determined level.

19. The dividing method of claim 12, further comprising:
determining a level corresponding to the divisor;
adjusting the criterion using the determined level; and
adjusting and outputting the division result using the determined level.

20. The dividing method of claim 12, wherein the criterion is the maximum value among multiplies of 2 that are less than the divisor.

21. A dividing apparatus, comprising:
a first Coordinate Rotation Digital Computer (CORDIC) for receiving a first source coordinate point having a divisor as an x-axis coordinate and 0 as a y-axis coordinate as an input, sequentially performing a plurality of rotation stages on the first source coordinate point to cause the first source coordinate point to reach a first target coordinate point having a criterion as an x-axis coordinate, and outputting a rotation direction used in each of the rotation stages; and
a second CORDIC for receiving a second source coordinate point having a dividend as an x-axis coordinate and 0 as a y-axis coordinate as an input and outputting a division result acquired by rotating the second source coordinate point using the rotation direction provided from the first CORDIC and a predetermined rotation angle for each of the rotation stages.

22. The dividing apparatus of claim 21, wherein the first CORDIC comprises a plurality of CORDIC ladders corresponding to the plurality of rotation stages, each of which compares the divisor or an x-axis coordinate output from its previous CORDIC ladder with the criterion and outputs the rotation direction based on the comparison result.

23. The dividing apparatus of claim 22, wherein the first CORDIC determines the rotation direction in such a way to increase an angle between the divisor or a coordinate point output from the previous CORDIC ladder and an x axis if the divisor or the x-axis coordinate from a previous CORDIC ladder is greater than the criterion and determines the rotation direction in such a way to reduce the angle between the divisor or the coordinate point output from the previous CORDIC ladder and the x axis if the divisor or the x-axis coordinate output from the previous CORDIC ladder is less than the criterion.

24. The dividing apparatus of claim 21, wherein the second CORDIC comprises a plurality of CORDIC ladders corresponding to the plurality of rotation stages, each of which rotates the second source coordinate point or a coordinate point output from its previous CORDIC ladder using a rotation direction provided from the first CORDIC and a predetermined rotation angle for each of the rotation stages.

24. The dividing apparatus of claim 22, wherein the second CORDIC comprises a plurality of CORDIC ladders corresponding to the plurality of rotation stages, each of which rotates the second source coordinate point or a coordinate point output from its previous CORDIC ladder using a rotation direction provided from the first CORDIC and a predetermined rotation angle for each of the rotation stages.

26. A dividing method, comprising:
sequentially performing a plurality of rotation stages on a first source coordinate point having a divisor as an x-axis coordinate and 0 as a y-axis coordinate to cause the first source coordinate point to reach a first target coordinate point having a criterion as an x-axis coordinate;
outputting a rotation direction used in each of the rotation stages;
acquiring a second target coordinate point by rotating a second source coordinate point having a dividend as an x-axis coordinate and 0 as a y-axis coordinate using the rotation direction and a predetermined rotation angle for each of the rotation stages; and
outputting an x-axis coordinate of the second target coordinate point as a division result.

27. The dividing method of claim 26, wherein the divisor or an x-axis coordinate of a coordinate point output from a previous rotation stage with the criterion and the rotation direction for each of the rotation stages is determined based on the comparison result.

28. The dividing method of claim 27, wherein the rotation direction is determined in such a way to increase an angle between the divisor or a coordinate point output from a previous rotation stage and an x axis if the divisor or the x-axis coordinate from the previous rotation stage is greater than the criterion and is determined in such a way to reduce the angle between the divisor or the coordinate point output from the previous rotation stage and the x axis if the divisor or the x-axis coordinate output from the previous rotation stage is less than the criterion.
